(19) United States
(12) Patent Application Publication
(10) Pub. No.: US 2020/0324518 A1
(43) Pub. Date: Oct. 15, 2020

(54) BIODEGRADABLE FILMS FOR DISPOSABLE GOODS

(71) Applicant: Madico, Inc., Pinellas Park, FL (US)

(72) Inventors: Philip Canale, Pinellas Park, FL (US); Marina Temchenko, Pinellas Park, FL (US)

(21) Appl. No.: 16/849,414

(22) Filed: Apr. 15, 2020

Related U.S. Application Data
(60) Provisional application No. 62/833,838, filed on Apr. 15, 2019.

(51) Int. Cl. B32B 15/09; C09J 7/29; C09J 7/38; B32B 7/12; B32B 15/20; B32B 27/36

(52) U.S. Cl. CPC B32B 15/09; C09J 7/29; C09J 7/385; B32B 7/12; B32B 15/20; B32B 2405/00; C09J 2433/00; B32B 2255/10; B32B 2255/26; B32B 2307/7163; B32B 2307/40; B32B 27/36

(57) ABSTRACT

Film having a biodegradable component are provided where a biodegradable urethane coating is applied to one side of a substrate layer. A pressure sensitive adhesive can be applied to the other side of the substrate layer. The substrate layer itself can be formed of one or more biodegradable materials, including biodegradable polymers. The film can form a portion of a multi-ply laminate and can include one or more ultraviolet or visible light absorbers as well as metallized layers.

### CROSS-REFERENCE TO RELATED APPLICATIONS

This application claims the benefit of U.S. Provisional Application No. 62/833,838, filed on Apr. 15, 2019. The entire disclosure of the above application is incorporated herein by reference.

### FIELD

The present technology relates to biodegradable materials, including biodegradable films, layers, and coatings for protection of various substrates, materials, and laminate structures, where such biodegradable films, layers, and coatings can be transparent.

### INTRODUCTION

This section provides background information related to the present disclosure which is not necessarily prior art.

Many governments and peoples are becoming aware of problems related to disposal of non-biodegradable materials. Ocean and ground water contamination are just some of the problems associated with non-biodegradable waste materials. The scale of such problems can be considered in view of the following facts: (1) about 400 metric tons of plastic waste is generated every year; (2) enough plastic is thrown away each year to circle the earth four times; (3) in the Los Angeles, Calif. area alone, about 10 metric tons of plastic fragments are carried into the Pacific Ocean every day; (4) about 50 percent of plastic is incorporated into single-use articles or materials; (5) the average American throws away approximately 185 pounds of plastic per year; and (6) plastic accounts for around 10 percent of the total waste generated by humans.

In response, many products are being required to be biodegradable and even more importantly compostable. There is accordingly a need to substitute materials and modify applications employing non-biodegradable plastics with biodegradable and compostable materials.

### SUMMARY

The present technology includes articles of manufacture, systems, and processes that relate to protective films having biodegradable components.

Films having a biodegradable component are provided that include a biodegradable urethane coating and a substrate layer, where the biodegradable urethane coating is applied to at least one side of the substrate layer. The substrate layer itself can comprise a biodegradable polymer. A pressure sensitive adhesive can be applied to the other side of the substrate layer. The film can also form a portion of a multi-ply laminate, where each ply includes the biodegradable urethane coating, the substrate layer, and the pressure sensitive adhesive, where the biodegradable urethane coating is applied to one side of the substrate layer and the pressure sensitive adhesive applied to the other side of the substrate layer. The biodegradable urethane coating can include an ultraviolet light absorber and/or a visible light absorber. The film can further include a metallized layer. Hydrophobic character can be imparted to the biodegradable urethane coating by including silica therein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic side view of a biodegradable release coating applied to a poly(lactic acid) substrate.

FIG. 2 is a schematic side view of a biodegradable anti-graffiti film, where a biodegradable anti-stain coating and a biodegradable pressure sensitive adhesive are applied to opposite sides of a cellulose acetate substrate to form a 1-ply biodegradable anti-graffiti film.

FIG. 3 is a schematic side view of a 4-ply biodegradable anti-graffiti film based upon the 1-ply biodegradable anti-graffiti film of FIG. 2, further including a biodegradable release liner.

FIG. 4 is a schematic side view of a biodegradable ultraviolet absorbent 5% visible light transmission (VLT) coating applied to a cellulose acetate substrate.

FIG. 5 is a schematic side view of an electromagnetic radiation reflective biodegradable film.

FIG. 6 is a schematic side view of an ultraviolet and visible light blocking biodegradable film.

FIG. 7 is a schematic side view of a hydrophobic coating applied to a biodegradable substrate.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to providing a biodegradable material that can be transparent, semitransparent, or opaque. The biodegradable material can be formed as one or more films, layers, or coatings that can be applied or assembled with one or more other materials, including one or more additional films, layers, or coatings. In manufacture thereof, the biodegradable material can be applied to the one or more other materials or the one or more other materials can be applied to the biodegradable material. The biodegradable material can have a low surface tension so as to not adhere to surfaces that may have high adhesion properties, such as a pressure sensitive adhesive. The biodegradable material can, in certain instances, contain one or more dyes, colorants, opacifiers, absorbants, reflectants, and/or other ingredients to block certain wavelengths of electromagnetic radiation. The biodegradable material can also be used to provide any number of other properties, ranging from anti-soil, superhydrophobic, and stain resistance, to a hard coat capable of enhancing scratch resistance.

Protective liners as well as other materials used in various disposable applications that are made from paper are common. Most items made from paper degrade adequately to be referred to as biodegradable and compostable according to ASTM D6400. However, these paper-based materials can have limitations in moisture absorptivity, shrinkage, clarity, and transparency, as well as shortcomings in other physical properties. Also, such materials can be difficult to work with in a roll-to-roll manufacturing process. The use of transparent polymers such as modified cellulose based materials, chitosan and chitosan derivatives, some polyanhydrides and polyanhydride-ester copolymers, cellulose acetate, cellulose butyrate, cellulose propionate as well as certain poly-lactic acid and poly-lactic acid copolymers, poly-glycolic acid, as well as biodegradable polyesters such as polycaprolatone based polymers and copolymers, among others, do not suffer from these limitations. Even polymers made from starch and other vegetable sources such as Mater-BI can be superior to paper in many applications. Some biodegradable materials such as polyphosphazenes have the added advantage of being flame retardant. Even some chemically modified polyethylene terephthalate copolymers and polyethylene terephthalates with EcoPure and ENSO RESTORE additives and are said be approaching the standard of being compostable.

The present technology can employ various substrates, including various biodegradable substrates, cellulose polymers, and papers that are in most instances biodegradable and compostable, or in certain embodiments, nonbiodegradable non-compostable materials can be used. The uses envisioned in the present technology include protective films such an anti-graffiti film that are currently made of polyethylene terephthalate nonbiodegradable/non-compostable film, release liners which are disposable films typically used to protect surfaces before installation. They are most often used to keep pressure sensitive adhesives from adhering to surfaces prematurely. Another application includes disposable eye protection used to protect eyes from harmful UV radiation after medical or dental procedures as well as protecting eyes during sun bathing.

In addition to the film, specialized coatings are often put onto the film for functional purposes. In the case of the disposable glasses that protect eyes from UV and visible electromagnetic radiation, a coating is formulated to block exposure to bright visible light as well as harmful UV radiation. In the instance of anti-graffiti film, a coating can be applied that will resist ink and paint making stain removable and making the film last longer. Other coatings on the film may include a metallized layer that may block and reflect electromagnetic radiation extending to the infrared region making the film more of a heat as well as visible light and UV energy barrier. Other coatings on the film may be superhydrophobic to be used in diagnostic disposable strips. In all these cases, the coating must be biodegradable, compostable, or at a minimum allow the film to biodegrade quickly enough and without bio contamination to be termed as compostable. Thus, many of these functional coatings are themselves biodegradable and/or compostable. In the case of a thin metallized layer, aluminum can be used as it can be oxidized by reaction with water to become inert and nonhazardous.

In the case of organic coatings that may block harmful amounts of UV or visible radiation the coating is preferred to be biodegradable and compostable. Such coatings can be made from but not limited to polycaprolactone functionalized polymers as well as hydroxyl containing modified cellulose derivative such as cellulose acetate, propionate, and butyrate among others. These materials can be cross-linked with isocyanates utilizing current urethane technology to achieve desired properties. Care must be taken in the selection of additives and ingredients so as not to impede biodegradation significantly.

In the case of anti-graffiti film, paint and ink protection usually involves the addition of additives to lower the surface tension of the coating. These additives cause water to be repelled which can inhibit biodegradation. The levels used as well as the chemical structures need to be considered in the formulation of these coatings. Even with the low surface tension biological entities may decompose urea, urethane, and ester linkages in order to not impede biodegradation to an exceedingly high degree. These polymers such as polylactic acids, polyethylene glycols, and polycaprolactones especially those of oligomeric or lower molecular weights may be functionalized with unsaturation or other reactive moieties, in particularly acrylates or methacrylates to create a UV or visible light curing coating or other thermal methods of cure.

Another consideration in these films is that in certain applications they may need to be mounted. In these instances, pressure sensitive adhesives can be used. The pressure sensitive adhesive can be chosen so as to not inhibit biodegradation or compostable properties. For instance, polyisobutylene based pressure sensitive adhesives are not biodegradable. However, some acrylic based adhesives and tackifiers, especially those based on terpenes, soybean oils, and other natural sources, can be used.

Particular embodiments of the present technology include films having a biodegradable component that include a biodegradable urethane coating and a substrate layer, where the biodegradable urethane coating is applied to one side of the substrate layer. The biodegradable urethane coating can be formed from various coating solutions that are applied to the substrate layer, in liquid, semiliquid, or film form, by calendaring, spraying, by roll-to-roll methods, that can include various drying and/or curing steps, including thermal energy and/or ultraviolet curing and the inclusion of photoinitiators.

The biodegradable urethane coating can be formed from one or more various monomers and one or more various oligomers reacted to form carbamate linkages. Examples of the biodegradable urethane coating include those formed from polyisocyantes and polyols, including various acrylates, photoinitiators, surface modifiers, and solvents. Certain embodiments include where the biodegradable urethane coating is formed from a coating solution comprising one or more caprolactone polyols, including urethane methacrylate of caprolactone triol. Particular embodiments include where the biodegradable urethane coating is formed from a coating solution comprising urethane methacrylate of caprolactone triol, silicone acrylate, a photoinitiator, and a solvent. Other embodiments of the biodegradable urethane coating include those formed from a coating solution comprising a carbohydrate polymer and a polyisocyanate; e.g., a coating solution comprising cellulose acetate propionate, a polyisocyanate, a urethane catalyst, a solvent, and a silicone isocyanate.

The substrate layer can include various aspects. The substrate layer can include one or more materials, including one or more polymers. In certain embodiments, the substrate layer comprises a biodegradable polymer, such as various polyesters; e.g., poly(lactic acid). The substrate can include various biodegradable materials, including paper and various types of carbohydrate polymers, including various types of cellulose; e.g., cellulose acetate. Further examples of biodegradable substrates include poly(glycolic acid), poly(lactic-co-glycolic acid), as well as various vegetable oils and biomass in the formation of various polyurethanes.

Films having a biodegradable component can also include where the biodegradable urethane coating is applied to one side of the substrate layer and a pressure sensitive adhesive is applied to the other side of the substrate layer. The pressure sensitive adhesive can include an elastomer compounded with a suitable tackifier; e.g., a rosin ester. The elastomer can be based on an acrylic, a bio-based acrylate (e.g., a biological-based macromonomer grafted onto a backbone of acrylate), butyl rubber, ethylene-vinyl acetate (EVA) with high vinyl acetate content, and can be formulated in various ways, including hot-melt, with natural rubber, nitriles, silicone rubbers, etc. In certain embodiments, the pressure sensitive adhesive comprises a compostable acrylic adhesive.

The film including the biodegradable urethane coating on one side of the substrate layer and the pressure sensitive adhesive on the other side of the substrate layer can be used to form multi-ply laminates. For example, the film can have from two to ten plies, where each ply of the laminate includes a biodegradable urethane coating applied to one side of a substrate layer and a pressure sensitive adhesive applied to another side of the substrate layer. A release layer covering the outermost pressure sensitive adhesive of the laminate can be included to protect the pressure sensitive adhesive prior to application and use of the laminate. Certain embodiments can be formulated such that the release layer comprises a biodegradable polymer; e.g., poly(lactic acid).

Films having a biodegradable component can be formulated for various functions, including ultraviolet and visible light absorbance or reflectance. Certain embodiments include where the biodegradable urethane coating is formed with one or more ultraviolet light absorbers and/or visible light absorbers. An example of an ultraviolet light absorber includes 1, 3-bis-((2′-cyano-3′,3′-diphenylacryloyl)oxy)-2,2-bis-(((2′-cyano-3′,3′-diphenylacryloyl)oxy)methyl)-propane. An example of a visible light absorber includes Solvent Black 29. Various light reflectants can be incorporated, such as various metallized layers; e.g., an aluminum layer. Particular embodiments include where the biodegradable urethane coating comprises an ultraviolet light absorber, a visible light absorber, a carbohydrate polymer, and a polyisocyanate. Such biodegradable urethane coatings can be used in conjunction with various biodegradable substrates; e.g., cellulose acetate. Structures of such films can include various layer arrangements, including a biodegradable urethane coating applied to one side of a substrate layer, an adhesive applied to another side of the substrate layer, an aluminum layer applied to the adhesive, a second substrate layer supporting the aluminum layer, a pressure sensitive adhesive applied to the second substrate, and a release layer covering the pressure sensitive adhesive.

Films having a biodegradable component can also include a second substrate layer, where the biodegradable urethane coating is positioned between the substrate layer and the second substrate layer. In such instances, the biodegradable urethane coating can include an ultraviolet light absorber and/or a visible light absorber. Embodiments also include where the biodegradable urethane coating is formed from an adhesive comprising an ultraviolet light absorber, a visible light absorber, a urethane catalyst, a polyisocyanate, a poly(caprolactone) polyol, and a solvent. The substrate layer and/or the second substrate layer can include a biodegradable polymer; e.g., poly(lactic acid).

Films having a biodegradable component can further include where the biodegradable urethane coating is formed from a coating solution comprising silica. The silica can include various modified silica particles, including surface-treated silica nanoparticles and/or hydrophobic silica incorporating one or more polyalkyl siloxanes. Biodegradable urethane coatings including such silica particles can provide a hydrophobic surface that is weather resistant and can provide increased resistance to biodegradation of the urethane coating and/or the underlying substrate while the film is in use. These biodegradable urethane coatings can be applied to various biodegradable substrates, including biodegradable polymers such as poly(lactic acid). biodegradable urethane coating

Several benefits and advantages are attributable to the present technology. In certain cases, the biodegradable urethane coating, when placed or applied on a biodegradable or compostable plastic or polymer substrate, will not affect the biodegradability or compostability of the substrate. The biodegradable urethane coating can allow the film to act as a release layer or liner for a pressure sensitive adhesive, where such release layers are typically discarded and can now biodegrade or be composted. The film can exhibit enhanced stain or soil resistance; e.g., when providing a hydrophobic surface. The film can adhere to a surface by use of a pressure sensitive adhesive, where the film can be used to block harmful electromagnetic radiation in the visible and/or ultraviolet regions. The film also be formulated with one or more reflectants (e.g., a metallized layer) to act to reflect infrared radiation. Such applications can find particular uses as window films for buildings and vehicles. Other applications include optically clear films that can be applied to various surfaces to function as anti-graffiti films, especially where multiple plies are used, allowing outer plies to be successively removed to reveal fresh, undamaged surfaces. Ultraviolet and/or visible light protective films having a biodegradable component according to the present technology can be incorporated into many products in order to improve biodegradation or compostability over other synthetic or petroleum-based films. Where the film includes a hydrophobic biodegradable urethane coating applied on a biodegradable substrate, the coating can protect the substrate from biodegradation by providing an outer face to repel weather or moisture, but which does not change biodegradability of the said substrate when the film is removed for replacement and is to be discarded.

### EXAMPLES

Example embodiments of the present technology are provided with reference to the several figures enclosed herewith.

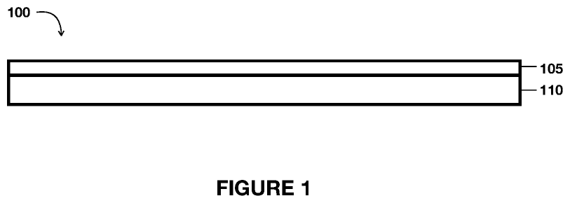

With reference to FIG. 1, an embodiment of a film 100 configured as a biodegradable release liner is shown, where a biodegradable urethane coating 105 is configured as a biodegradable release coating applied to substrate 110 including 92 gauge poly(lactic acid).

TABLE 1
Biodegradable Release Coating Formula 1 (UV curable).

| component | weight % |
|---|---|
| urethane methacrylate of caprolactone triol | 35 |
| methyl ethyl ketone | 62 |
| silicone acrylate | 0.3 |
| 1-hydroxycyclohexyl phenyl ketone | 2.7 |
| (photoinitiator) | |

TABLE 2
Biodegradable Release Coating Formula 2.

| component | weight % |
|---|---|
| urethane methacrylate of caprolactone triol | 35 |
| methyl ethyl ketone | 62 |
| silicone acrylate | 0.3 |
| 1-hydroxycyclohexyl phenyl ketone | 2.7 |
| (photoinitiator) | |

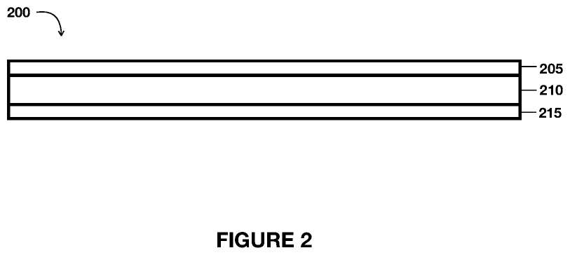

With reference to FIG. 2, an embodiment of a film 200 configured as a biodegradable anti-graffiti film (1-ply) is shown, where a biodegradable urethane coating 205 (configured as a biodegradable anti-stain coating) and a biodegradable pressure sensitive adhesive 215 are applied to opposite sides of a substate 210 (configured as a 0.010 inch cellulose acetate substrate).

TABLE 3
Formulae for Pressure Sensitive Adhesive and
Biodegradable Anti-Stain Coating.

| | biodegradable pressure | anti-stain coating |
|---|---|---|
| component | adhesive (weight %) | (weight %) |
| BioTAK ™ S100 | 100 | n/a |
| Desmodur N3300 | n/a | 3 |
| urethane catalyst | n/a | 0.0001 |
| cellulose acetate propionate | n/a | 16.7 |
| methyl ethyl ketone | n/a | 80 |
| urea silicone isocyanate | n/a | 0.3 |

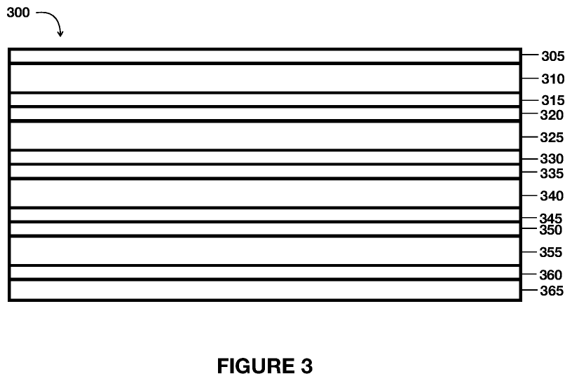

With reference to FIG. 3, an embodiment of a film 300 configured as a 4-ply biodegradable anti-graffiti film based upon the 1-ply biodegradable anti-graffiti film of FIG. 2 is shown. Successive layers from top to bottom include: a biodegradable urethane coating 305 (configured as a biodegradable anti-stain coating); a substate 310 (configured as 0.003 inch cellulose acetate); biodegradable pressure sensitive adhesive 315; a biodegradable urethane coating 320 (configured as a biodegradable anti-stain coating); a substate 325 (configured as 0.003 inch cellulose acetate); biodegradable pressure sensitive adhesive 330; a biodegradable urethane coating 335 (configured as a biodegradable anti-stain coating); a substate 340 (configured as 0.003 inch cellulose acetate); biodegradable pressure sensitive adhesive 345; a biodegradable urethane coating 350 (configured as a biodegradable anti-stain coating); a substate 355 (configured as 0.003 inch cellulose acetate); biodegradable pressure sensitive adhesive 360; and a 92 gauge poly(lactic acid) biodegradable release layer 365. It should be noted that the various biodegradable urethane coatings 305, 320, 335, 350 can be the same formulation or different formulations. Likewise, the various substrates 310, 325, 340, 355 can be the same or different compositions and the pressure sensitive adhesives 315, 330, 345, 360 can be the same formulation or different formulations.

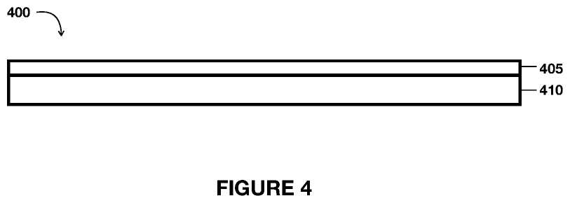

With reference to FIG. 4, an embodiment of a biodegradable film 400 for UV blocking and low visible light transmission is shown, where the film 400 has a biodegradable urethane coating 405 (configured as a biodegradable ultraviolet absorbent 5% visible light transmission (VLT) coating) applied to a substrate 410 including 0.010 inch cellulose acetate is shown.

TABLE 4
Formula for UV Absorbent 5% VLT Coating.

| component | weight % |
|---|---|
| Solvent Black 29 | 0.36 |
| Solvent Orange 11 | 0.05 |
| Solvent Blue 67 | 0.07 |
| 1,3-bis-((2′-cyano-3′,3′- | 0.23 |
| diphenylacryloyl)oxy)-2,2- | |
| bis-(((2′-cyano-3′,3′-diphenyl- | |
| acryloyl)oxy)methyl)-propane | |
| (UV absorber) | |
| Solvent Red 124 | 0.03 |
| Solvent Violet 36 | 0.02 |
| methyl ethyl ketone | 79.09 |
| urethane catalyst | 0.0001 |
| Desmodur N3300 | 3.00 |
| cellulose acetate proprionate | 17.15 |

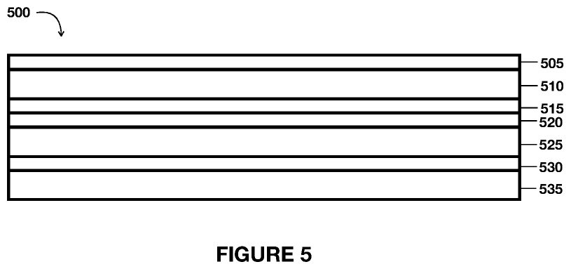

With reference to FIG. 5, an embodiment of a film 500 configured as an electromagnetic radiation reflective biodegradable film is shown. The film 500 has a series of layers configured as follows: a biodegradable urethane coating 505 (configured as a biodegradable anti-stain weatherable coating); a substrate 510 (configured as 0.002 inch clear cellulose acetate); a biodegradable laminate adhesive 515; a metallized aluminum layer 520; a second substrate 525 (configured as 0.002 inch clear cellulose acetate); a biodegradable pressure sensitive adhesive 530; and a biodegradable release liner 535.

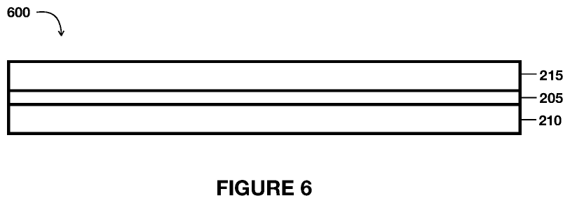

With reference to FIG. 6, an embodiment of film 600 configured as an ultraviolet and visible light blocking biodegradable film is shown. A biodegradable urethane coating 210 (configured as a biodegradable UV absorbent 5% visible light transmission (VLT) lamination adhesive) is sandwiched by a first substrate (configured as 0.005 inch polylactic acid) and a second substrate (configured as 0.005 inch polylactic acid).

TABLE 5
Formula for Biodegradable UV absorbent
5% VLT Lamination Adhesive.

| component | weight % |
|---|---|
| Solvent Black 29 | 0.36 |
| Solvent Orange 11 | 0.05 |
| Solvent Blue 67 | 0.07 |
| 1,3-bis-((2′-cyano-3′,3′- | 0.23 |
| diphenylacryloyl)oxy)-2,2- | |
| bis-(((2′-cyano-3′,3′-diphenyl- | |
| acryloyl)oxy)methyl)-propane | |
| Solvent Red 124 | 0.03 |
| Solvent Violet 36 | 0.02 |
| methyl ethyl ketone | 72.24 |
| urethane catalyst | 0.0001 |
| Desmodur I | 6.00 |
| Desmodur N3300 | 4.00 |
| poly(caprolactone) triol | 10.0 |
| poly(caprolactone) diol | 7.0 |

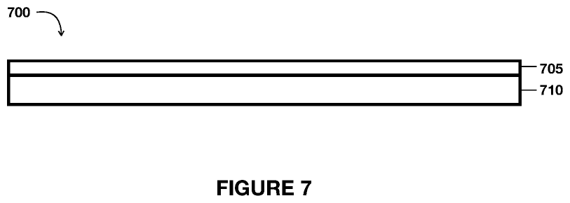

With reference to FIG. 7, an embodiment of a film 700 configured as a hydrophobic coating on a biodegradable substrate is shown. A biodegradable urethane coating 705 (configured as a super-hydrophobic coating) is applied to a biodegradable substrate 710.

TABLE 6
Formula for Super-Hydrophobic Coating

| component | solids (%) | weight (g) |
|---|---|---|
| MR-102 | 100 | 14.23 |
| isopropyl alcohol | 0 | 93.28 |
| AR-37 | 40 | 1.05 |
| NanoBYK 3605 (surface- | 100 | 10.03 |
| treated silica nanoparticles) | | |
| Sylophobic 200 (hydrophobic | 100 | 13.99 |
| silica incorporating a | | |
| polyalkyl siloxane) | | |
| Irgacure 127 (photoinitiator) | 100 | 1.46 |
| Irgacure 184 (photoinitiator) | 100 | 0.87 |
| Laromer 9103 (oligomeric | 100 | 2.10 |
| amine modified acrylate) | | |

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A film having a biodegradable component comprising:
a biodegradable urethane coating; and
a substrate layer, wherein the biodegradable urethane coating is applied to one side of the substrate layer.

2. The film of claim 1, wherein the biodegradable urethane coating is formed from a coating solution comprising urethane methacrylate of caprolactone triol.

3. The film of claim 1, wherein the biodegradable urethane coating is formed from a coating solution comprising urethane methacrylate of caprolactone triol, silicone acrylate, a photoinitiator, and a solvent.

4. The film of claim 1, wherein the substrate layer comprises a biodegradable polymer.

5. The film of claim 1, wherein the substrate layer comprises poly(lactic acid).

6. The film of claim 1, further comprising a pressure sensitive adhesive applied to the other side of the substrate layer.

7. The film of claim 6, wherein the pressure sensitive adhesive comprises a compostable acrylic adhesive.

8. The film of claim 6, wherein the biodegradable urethane coating is formed from a coating solution comprising a carbohydrate polymer and a polyisocyanate.

9. The film of claim 6, wherein the biodegradable urethane coating is formed from a coating solution comprising cellulose acetate propionate, a polyisocyanate, a urethane catalyst, a solvent, and a silicone isocyanate.

10. The film of claim 6, wherein the film is comprised by a laminate having a plurality of plies, each ply of the laminate including:
the biodegradable urethane coating;
the substrate layer, wherein the biodegradable urethane coating is applied to one side of the substrate layer; and
the pressure sensitive adhesive applied to the other side of the substrate layer.

11. The film of claim 10, further comprising a release layer covering the outermost pressure sensitive adhesive of the laminate.

12. The film of claim 11, wherein the release layer comprises a biodegradable polymer.

13. The film of claim 12, wherein the release layer comprises poly(lactic acid).

14. The film of claim 1, wherein the biodegradable urethane coating comprises a member selected from the group consisting of an ultraviolet light absorber, a visible light absorber, and combinations thereof.

15. The film of claim 1, wherein the biodegradable urethane coating comprises an ultraviolet light absorber, a visible light absorber, a carbohydrate polymer, and a polyisocyanate.

16. The film of claim 15, wherein the substrate layer comprises cellulose acetate.

17. The film of claim 1, further comprising a metallized layer.

18. The film of claim 1, further comprising:
an adhesive applied to the other side of the substrate layer;
an aluminum layer applied to the adhesive;
a second substrate layer supporting the aluminum layer;
a pressure sensitive adhesive applied to the second substrate; and
a release layer covering the pressure sensitive adhesive.

19. The film of claim 1, further comprising a second substrate layer, where the biodegradable urethane coating is positioned between the substrate layer and the second substrate layer.

20. The film of claim 19, wherein the biodegradable urethane coating comprises a member selected from the group consisting of an ultraviolet light absorber, a visible light absorber, and combinations thereof.

21. The film of claim 19, wherein the biodegradable urethane coating is formed from an adhesive comprising an ultraviolet light absorber, a visible light absorber, a urethane catalyst, a polyisocyanate, a poly(caprolactone) polyol, and a solvent.

22. The film of claim 19, wherein the substrate layer, the second substrate layer, or both the substrate layer and the second substrate layer comprises a biodegradable polymer.

23. The film of claim 19, wherein the substrate layer, the second substrate layer, or both the substrate layer and the second substrate layer includes poly(lactic acid).

24. The film of claim 1, the biodegradable urethane coating is formed from a coating solution comprising silica.

25. The film of claim 24, wherein the silica is comprised by a member selected from a group consisting of surface-treated silica nanoparticles, hydrophobic silica incorporating a polyalkyl siloxane, and combinations thereof.

26. The film of claim 24, wherein the substrate layer comprises a biodegradable polymer.
